(19) United States
(12) Patent Application Publication
(10) Pub. No.: US 2017/0225077 A1
(43) Pub. Date: Aug. 10, 2017

(54) SPECIAL VIDEO GENERATION SYSTEM FOR GAME PLAY SITUATION

(71) Applicant: MINKONET CORPORATION, Seoul (KR)

(72) Inventors: TAE WOO KIM, GYEONGGI-DO (KR); DONG HWAL LEE, GYEONGGI-DO (KR); WON GIL RYIM, GYEONGGI-DO (KR)

(73) Assignee: MINKONET CORPORATION, Seoul (KR)

(21) Appl. No.: 15/054,153

(22) Filed: Feb. 26, 2016

(30) Foreign Application Priority Data
Feb. 4, 2016 (KR) 10-2016-0013873

(51) Int. Cl. A63F 13/63; A63F 13/86; A63F 13/525

(52) U.S. Cl. CPC A63F 13/63; A63F 13/525; A63F 13/86

(57) ABSTRACT

Provided is a special video generation system for a game play situation, generating and providing a special video of a game play situation being played on a game terminal, for example, as a 360-degree video or a virtual reality (VR) video. According to the special video generation system for a game play situation, the special video of the game play situation may be easily generated without greatly increasing a calculation load of the game terminal. In addition, according to the special video generation system for a game play situation, interest of game users in playing games may be aroused by providing the special video of the game play situation.

### CROSS-REFERENCE TO RELATED APPLICATION

This application claims the benefit of Korean Patent Application No. 10-2016-0013873, filed on Feb. 4, 2016in the Korean Intellectual Property Office, the disclosure of which is incorporated herein in its entirety by reference.

### TECHNICAL FIELD

One or more embodiments relate to a special video generation system for a game play situation, and more particularly, to a special video generation system for a game play situation, capable of generating a special video of a situation of a game being played on a game terminal, for example, as a 360-degree video or a virtual reality (VR) video.

### DESCRIPTION OF THE BACKGROUND ART

Recently, video service providing systems such as YouTube have enabled users to search for and play back videos of various fields. In addition, as smart phones and tablets have been commercialized, the number of games that can be played not only on a personal computer or a gaming device but also on a mobile device is increasing, and users of such games is also increasing in number. Thus, more and more users are enjoying games by uploading a game play video of their own to a video sharing service website or watching a broadcast of games played by other users via a streaming service.

Aside from this, the number of users who watch a game by taking a 360-degree video by using a 360-degree camera or a virtual reality (VR) video by using a virtual reality apparatus is also increasing. Video services such as YouTube started providing 360-degree videos or VR videos, and standards for such videos are developed, and the same video can now be easily watched on different display devices. Also, a multi-layer video which refers to multiple videos of a single situation taken using two or more cameras is also increasingly watched. A user who watches a multi-layer video may select a video of each camera as desired.

360-degree videos, VR videos, and multi-layer videos described above (hereinafter referred to as a ‘special video’) are generated using two or more cameras, and are usually taken using special purpose cameras for taking the above special videos.

When taking a video image of an actual situation which is not virtual reality and creating a special video of the actual situation, a special purpose camera is used to take a video image and convert the same into a special video.

In regard to a three-dimensional game reproduced in virtual space, an actual play situation of the game is usually displayed on a two-dimensional display, and thus, it is difficult to generate a special video of the three-dimensional game as the special video described above. Even when a video of a screen, on which a game play situation is being displayed, is taken using a special purpose camera for 360-degree videos, a 360-degree video of the game play situation is not obtained.

While a method of adding a function of generating a special video such as a 360-degree video to a game program to record a game play situation may be considered, a very high operation capability is required to generate a 360-degree video by integrating videos taken using a plurality of cameras, and this may cause the problem that play of the game itself is not easy on a game terminal.

Thus, a method of generating a special video of a game play situation of a three-dimensional game to further increase the interest of game users is required.

### SUMMARY

One or more embodiments include a special video generation system for a game play situation, capable of effectively generating a special video of a play situation of a three-dimensional game, such as a 360-degree video, a virtual reality (VR) video or a multi-layer video, without greatly increasing a calculation load of a game terminal.

Additional aspects will be set forth in part in the description which follows and, in part, will be apparent from the description, or may be learned by practice of the presented embodiments.

According to one or more embodiments, a special video generation system for a game play situation, provides a game video of a game play situation being played on a game terminal, and includes: a storage module configured to store object information defining three-dimensional shapes and textures of objects, wherein things, characters, and backgrounds appearing in three-dimensional virtual space inside a game are defined as the objects; a script receiving module configured to receive script information from the game terminal via a network and store the script information in the storage module, wherein the script information includes information about states, in which the objects are displayed in the virtual space, as numerical data recorded at predetermined intervals so as to reproduce a game play video by linking the script information with the object information; and a camera placement module configured to place, in game virtual space, a plurality of virtual cameras generating a game play video by using the script information; a camera video extracting module configured to reproduce a game play situation by linking the script information and the object information stored in the storage module and extract virtual camera videos respectively taken by the plurality of virtual cameras placed by the camera placement module and store the extracted camera videos in the storage module; an integrated video generation module configured to generate an integrated video corresponding to one of a 360-degree video, a virtual reality (VR) video, and a multi-layer video by integrating the virtual camera videos respectively extracted by the camera video extraction module and store the integrated video in the storage module; an integrated video transmitting module configured to transmit the integrated video generated by the integrated video transmitting module and stored in the storage module, via a network; and an integrated video server configured to receive the integrated video from the integrated video transmitting module and provide the integrated video via streaming.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view illustrating a special video generation system for a game play situation, according to an embodiment of the inventive concept;

FIG. 2 is a block diagram illustrating the special video generation system for a game play situation of FIG. 1; and

FIG. 3 is a diagram for describing a multi-layer video from among integrated videos provided by the special video generation system for a game play situation illustrated in FIG. 1.

### DETAILED DESCRIPTION OF EMBODIMENTS

Hereinafter, exemplary embodiments of the inventive concept will now be described more fully.

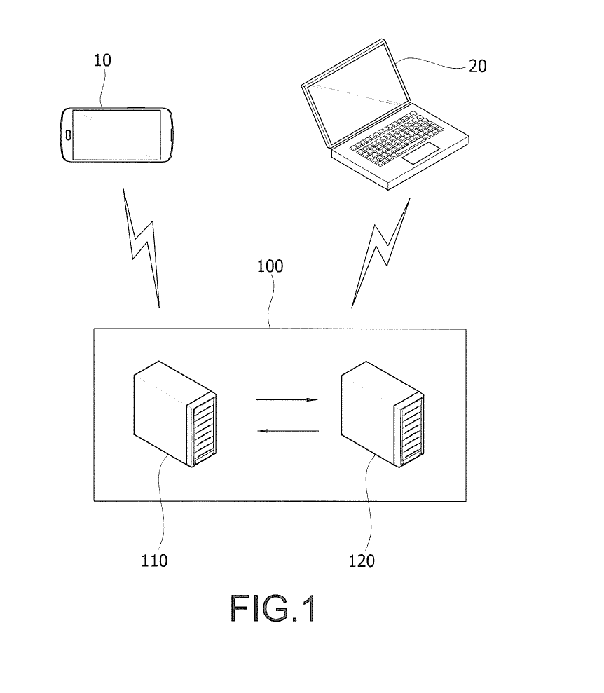

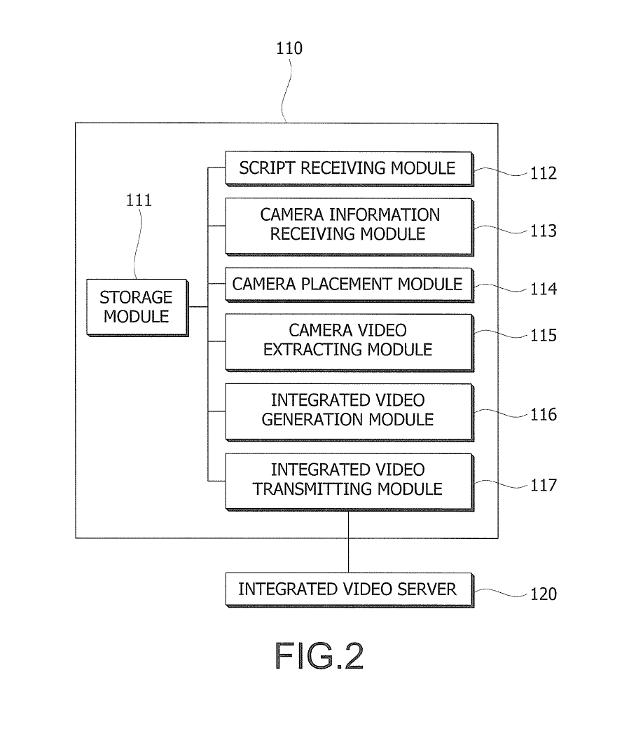

FIG. 1 is a schematic view illustrating a special video generation system 100 for a game play situation, according to an embodiment of the inventive concept. FIG. 2 is a block diagram illustrating the special video generation system 100 for a game play situation of FIG. 1.

Referring to FIGS. 1 and 2, the special video generation system 100 for a game play situation, according to the present embodiment, includes an integrated video generation system 110 and an integrated video server 120.

Referring to FIG. 2, the integrated video generation system 110 includes a storage module 111, a script receiving module 112, a camera information receiving module 113, a camera placement module 114, a camera video extracting module 115, an integrated video generation module 116, and an integrated video transmitting module 117.

The special video generation system 100 for a game play situation, according to the inventive concept, is directed to providing a game play video of a game operated on a game terminal 10 based on movement of things, characters, and backgrounds, which appear in a three-dimensional virtual space of the game and are defined as objects. Data defining three-dimensional shapes and textures of objects appearing in a game as described above is defined as object information. An object-based game is operated as objects move or their form is changed according to instructions describing movement of the objects in virtual space. A game play situation may be recorded by recording movement of the objects as numerical data at predetermined intervals. Also, a game play situation may be reproduced completely identically by linking the numerical data with the object information.

Data obtained by recording states of objects appearing in virtual space of a game while the game is being played on the game terminal 10, as numerical data at predetermined intervals, will be referred to as script information.

The inventive concept is based on the assumption that information about a game play situation recorded via the game terminal is used in a method of recording script information as described above while playing a game on the game terminal 10. In regard to a game developed based on three-dimensional objects, it is easy to extract and store script information as described above.

The game terminal 10 may be a mobile device such as a smart phone or a tablet, or a gaming device, a smart TV or a personal computer.

The script receiving module 112 may receive script information as described above from the game terminal 10 via a network and store the script information in the storage module 111. The script receiving module 112 may receive entire script information of a game that has been played for a predetermined period of time, from the game terminal 10, or may receive, in real time, real-time script information of a game that is currently being played on the game terminal 10. Hereinafter, description will focus on an embodiment in which the script receiving module 112 receives script information of a game play situation of the game terminal 10 in real time.

The storage module 111 is a memory device storing data processed by the integrated video generation system 110. Also, object information of all objects used by games played on the game terminal 10 is stored in the storage module 111 in advance. That is, in the storage module 111, object information defining three-dimensional shapes and textures of objects such as things, characters, and backgrounds appearing in three-dimensional virtual space in a game is stored.

As entire object information used in the game terminal 10 is stored also in the storage module 111, the integrated video generation system 110 may reproduce a game play situation by using just the script information received by the script receiving module 112 and the object information stored in the storage module 111.

When object information and script information are available as described above, the integrated video generation system 110 may reproduce a game play situation in virtual space by linking the object information and the script information with each other.

Before reproducing a game play situation as above, the number of virtual cameras in virtual space, in which the game play situation is to be generated as an image, and locations and directions of the virtual cameras are to be set. Various special videos may be generated according to the number, locations, and directions of the virtual cameras.

The camera information receiving module 113 may receive locations and directions of cameras placed in virtual space of a game as camera information and stores the camera information in the storage module 111. The camera information receiving module 113 may receive camera information from an additional input device provided in the integrated video generation system 110 or may receive camera information from a state of a camera object included in script information received from the game terminal 10. According to circumstances, camera information set by an operator of the integrated video generation system 110 may be received.

The camera placement module 114 may place a plurality of virtual cameras in virtual space based on the camera information received via the camera information receiving module 113. When generating a game play video by linking object information and script information described above with each other, the camera placement module 114 determines at which location and in which direction in virtual space (from which viewpoint of a virtual camera) a game play video is to be generated.

For example, when generating a 360-degree video, a plurality of virtual cameras are placed in virtual space at a same point and in different directions. Unlike capturing of an image on the spot, in a system based on object information or script information as in the inventive concept, since the number of virtual cameras is not limited, a 360-degree video of a high image quality may be generated by arranging a very large number of virtual cameras.

In addition, when generating a virtual reality (VR) three-dimensional video, a pair of virtual cameras oriented towards a same point and spaced apart from each other may be set.

When generating a multi-layer video, a plurality of virtual cameras are set at different locations and in different directions. Particularly, in regard to a multi-layer video, virtual cameras maybe set for respective viewpoints of various characters appearing in a game.

The camera video extracting module 115 may reproduce a game play situation by linking the script information and the object information stored in the storage module 111, and extract videos respectively taken by the virtual cameras placed by the camera placement module 114, and store the videos in the storage module 111. The camera video extracting module 115 may extract virtual camera videos by using a game program (software) or a replay program specialized for game (software) (hereinafter referred to as a ‘game replayer’). When script information is available, a game replayer may reproduce (render) the same game situation as that on the game terminal 10 by using object information stored in the storage module 111. As described above, the method of using script information involves describing movement of all objects appearing in a game, with time, and thus, excellent effects of reproducing a game may be provided compared to a game data storing method according to the related art. For example, in a method of storing an input instruction of a game playing person according to the related art, it is impossible to reproduce movements of different objects that are randomly operated by a game replayer, each time in the same manner. However, when movement of all objects is stored as scripts as according to the inventive concept, the same game situation may always be reproduced.

While reproducing a game situation as described above, the camera video extracting module 115 may extract, as virtual camera videos of a game situation, a set of image frames with time, from respective viewpoints of the virtual cameras placed by the camera placement module 114.

The integrated video generation module 116 may integrate the respective virtual camera videos extracted the camera video extracting module 115 to generate an integrated video and stores the same in the storage module 111.

For example, when generating a 360-degree video, videos of virtual cameras placed at a same point and in different directions are mapped to and connected with one another to an integrated video according to standards for 360-degree videos. An integrated video in a 360-degree video format is generated an algorithm well-known in the art.

Likewise, the integrated video generation module 116 may generate an integrated video for VR in a display format for a VR apparatus. For example, an integrated video for VR, which reproduces a virtual three-dimensional space by displaying different images to both eyes of a user may be generated.

The integrated video generation module 116 may also generate, as an integrated video, a multi-layer video which allows a user to view videos of a same situation captured from viewpoints of different virtual cameras according to user's selection.

The integrated video transmitting module 117 transmits the integrated video generated by the integrated video generation module 116 and stored in the storage module 111, to the integrated video server 120 via a network.

The integrated video server 120 provides the integrated video to users via a streaming method through a network. As described above, when the script receiving module 112 receives a script in real time, the integrated video generation system 110 generates an integrated video in real time, and the integrated video server 120 provides the integrated video to multiple clients 20 in real time.

A game play situation may be broadcast to multiple viewers on-line by using the above-described method. Also, according to the present embodiment, unlike typical game broadcasting according to the related art where a game playing person broadcasts the same video as that displayed on the game terminal 10 during a game play, a completely different game play video of various viewpoints and effects from a video displayed on the game terminal 10 with respect to a same game situation may be broadcast online.

Hereinafter, an operation of the special video generation system 100 for a game play situation according to the present embodiment configured as above will be described.

First, when a user plays a game on the game terminal 10, the game terminal 10 extracts and transmits script information. A function of extracting and transmitting script information, performed by the game terminal 10, may be included in game software as default, or an additional application for performing the function may be developed and installed on a game. When the user activates the function of extracting script information while playing a game, the game terminal 10 transmits the extracted script information via a network.

In regard to a 360-degree video or a VR video, the whole area which is broader than an area actually displayed on a screen has to be rendered, and thus, a high resolution of 4K (4096×2160 pixels) is required. When such a high resolution image is stored, data of more than 1 GB is to be processed per second, and encoding data having a capacity of about 4 GB is generated per hour. Thus, when considering storage space and a data processing rate of a typical mobile device, it is difficult to generate a special video in real time. However, according to the inventive concept, instead of immediately capturing and recording a play video on the game terminal 10, only script information which is in the form of numerical data is extracted, and thus, a data capacity thereof is very small, and a calculation load added to the game terminal 10 is also small. In particular, unless a game terminal is included in a distribution processing server system having high calculation performance, it is impossible to generate a special video such as a 360-degree video of a high image quality in real time by using a typical game terminal, such as a mobile device, a tablet, or a personal computer. However, according to the inventive concept, just script information has to be extracted by the game terminal 10, and thus, a calculation load of the game terminal 10 is small, and a special video such as a 360-degree video is easy to generate.

The script receiving module 112 stores the script information received from the game terminal 10, in the storage module 111.

The camera information receiving module 113 receives an input of an operator of the integrated video generation system 110 or receives camera information based on a predesignated value. The camera placement module 114 places a virtual camera in virtual space based on camera setting information of the camera information receiving module 113.

The camera video extracting module 115 reproduces a game play situation by linking object information with the script information, and extracts a video taken from a viewpoint of each virtual camera and stores the video in the storage module 111.

The integrated video generation module 116 integrates videos extracted by the camera video extracting module 115 to generate a special video such as a 360-degree video, a VR video, or a multi-layer video as a game play video.

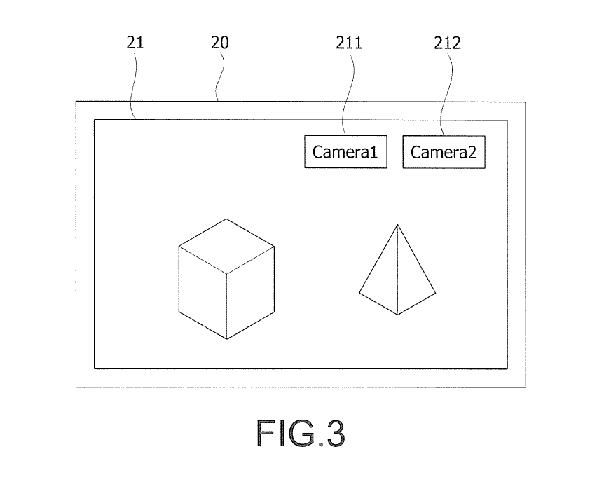

For example, in a battle game, only images exposed to a view of a game character of a game playing person are usually provided. However, if camera information is set from a view of a battle opponent, a game play situation may be reproduced from the standpoint of the opponent. In addition, to view not only a situation happening in front of the eyes of a game character but also a situation occurring behind the back of the game character, camera information may be set such that virtual cameras are respectively placed in front of and at the back of the game character, and a multi-layer video may be generated as an integrated video. A user who watches a game play situation may watch the same game play situation in different directions as a multi-layer video by clicking each of a “CAMERA 1” button 211 and a “CAMERA 2” button 212 with respect to the screen 21 as illustrated in FIG. 3.

When generating a 360-degree video in a similar manner, a game play situation of the front, back, left, and the right side may be viewed by adjusting a direction of an integrated video.

According to the above-described method, viewers may watch a game situation at a location and in a direction which cannot be viewed by the game playing person on the game terminal 10, and thus, interest in game broadcasting may be enhanced and diverse services may be provided.

The integrated video transmitting module 117 transmits the generated integrated video to the integrated video server 120.

The integrated video server 120 may store the integrated video received by the integrated video transmitting module 117 and provides the integrated video to a plurality of clients 20 via a network. The integrated video server 120 may provide a game play special video via real-time broadcasting, or may store the entire video and provide the same to the clients 20 via a streaming service.

Meanwhile, as described above, by providing the integrated vide generation system 110 including the storage module 111, the script receiving module 112, the camera information receiving module 113, the camera placement module 114, the camera video extracting module 115, the integrated video generation module 116, and the integrated video transmitting module 117 and assigning the integrated video generation system 110, which is separate and independent, to generate an integrated video, a calculation load of the game terminal 10 and the integrated video server 120 may be reduced, and an integrated video may be generated efficiently.

In particular, an integrated video is generated anew by linking object information and script information in the integrated video system 110, and thus, a video having a higher image quality than a game play video displayed on the game terminal 10 may be generated. In addition, as a calculation load is distributed by assigning the operation of generating an integrated video (special video), which requires a large amount of calculation, to a separate system, game broadcasting may be provided in real time via the game terminal 10 and the integrated video server 120 together without difficulty.

While preferred embodiments of the inventive concept have been described above, the scope and range of the inventive concept may also be differently configured from the structure described and illustrated above.

For example, while the camera information receiving module 113 and the camera placement module 114 are described above, the camera information receiving module 113 and the camera placement module 114 may be omitted from the special video generation system 100 for a game play situation. In this case, the number of virtual cameras and locations and angles of the virtual cameras are set to default values.

In addition, while the integrated video server 120 and the integrated video generation system 110 that are separately provided and connected to each other via a network are described above, according to circumstances, the integrated video generation system 110 and the integrated video server 120 may be included in a single system.

According to the special video generation system for a game play situation of the inventive concept, a special video of a game play situation may be easily generated without greatly increasing a calculation load of a game terminal.

According to the special video generation system for a game play situation of the inventive concept, the interest of game users in playing a game may be aroused by providing a special video of a game play situation.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

What is claimed is:

1. A special video generation system for a game play situation, providing a game video of a game play situation being played on a game terminal, the special video generation system comprising:
a storage module configured to store object information defining three-dimensional shapes and textures of objects, wherein things, characters, and backgrounds appearing in three-dimensional virtual space inside a game are defined as the objects;
a script receiving module configured to receive script information from the game terminal via a network and store the script information in the storage module, wherein the script information comprises information about states, in which the objects are displayed in the virtual space, as numerical data recorded at predetermined intervals so as to reproduce a game play video by linking the script information with the object information; and
a camera placement module configured to place, in game virtual space, a plurality of virtual cameras generating a game play video by using the script information;
a camera video extracting module configured to reproduce a game play situation by linking the script information and the object information stored in the storage module and extract virtual camera videos respectively taken by the plurality of virtual cameras placed by the camera placement module and store the extracted camera videos in the storage module;
an integrated video generation module configured to generate an integrated video corresponding to one of a 360-degree video, a virtual reality (VR) video, and a multi-layer video by integrating the virtual camera videos respectively extracted by the camera video extraction module and store the integrated video in the storage module;
an integrated video transmitting module configured to transmit the integrated video generated by the integrated video transmitting module and stored in the storage module, via a network; and
an integrated video server configured to receive the integrated video from the integrated video transmitting module and provide the integrated video via streaming.

2. The special video generation system of claim 1, wherein
the script receiving module receives the script information in real time, and
the camera video extracting module, the integrated video generation module, the integrated video transmitting module, and the integrated video server provide the integrated video of the game play situation via real-time broadcasting.

3. The special video generation system of claim 1, wherein
the storage module, the script receiving module, the camera placement module, the camera video extracting module, the integrated video generation module, and the integrated video transmitting module are provided in an independent integrated video generation system that is separate from the game terminal and the integrated video server,
wherein the integrated video generation system is connected to each of the game terminal and the integrated video server via a network.

4. The special video generation system of claim 1, further comprising:
a camera information receiving module configured to receive locations and directions of the plurality of virtual cameras in the virtual space, as camera information, and store the camera information in the storage module,
wherein the camera placement module places the plurality of virtual cameras in the virtual space based on the camera information received by the camera information receiving module.

5. The special video generation system of claim 4, wherein
the camera information receiving module receives the locations and the directions of the plurality of virtual cameras from a viewpoint of one of characters appearing in the game, as the camera information.

6. The special video generation system of claim 1, wherein
the camera placement module places the plurality of virtual cameras at same coordinates and in different directions,
wherein the integrated video generation module generates a 360-degree video by integrating the virtual camera videos.

7. The special video generation system of claim 1, wherein
the integrated video generation module generates the integrated video as a virtual reality (VR) video that is displayable using a VR apparatus.

8. The special video generation system of claim 1, wherein
the integrated video generation module generates the integrated video as a multi-layer video that is formed by integrating the virtual camera videos taken by the plurality of virtual cameras of different viewpoints with respect to a same situation and is displayable according to selection of a user.
